(19) United States
(12) Patent Application Publication
(10) Pub. No.: US 2009/0221375 A1
(43) Pub. Date: Sep. 3, 2009

(54) Wide-Screen Bar Top Gaming Machine and Method

(75) Inventors: Robert A. Luciano, JR., Reno, NV (US); Thomas N. Taxon, Reno, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/112,259

(22) Filed: Apr. 30, 2008

Related U.S. Application Data
(60) Provisional application No. 60/915,392, filed on May 1, 2007.

(51) Int. Cl. A63F 9/24; A63F 13/00

(52) U.S. Cl. 463/46; 463/30

(57) ABSTRACT

A bar top gaming machine cabinet is disclosed. The gaming machine cabinet includes a wide-screen display mounted in a top of the cabinet. Peripherals such as a currency acceptor and/or printer are installed in the interior of the cabinet beneath the display. Paper chutes extend from the peripherals to the exterior of the cabinet. This mounting scheme allows a bar top with a widescreen display to be implemented in the space of a typical bar top footprint. A method of assembling such a bar top gaming machine is also disclosed.

### RELATED APPLICATIONS

This application claims priority from provisional application 60/915,392, filed May 1, 2007.

The present application is also related to U.S. design patent application Ser. No. 29/248,671, for “Wide-Screen Gaming Machine,” filed Aug. 28, 2006, naming Robert A. Luciano, Jr. and Gordon H. Myers as inventors, now U.S. Design Patent D549,785.

All of the above referenced applications are hereby incorporated by reference in their entireties for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

This invention pertains generally to gaming machine cabinets found in establishments such as Nevada-style and Amerindian casinos, Amerindian bingo halls, and the like. More particularly, the present invention discloses a novel bar top gaming machine.

2. Description of the Related Art

Gaming machine cabinets have had certain traditional or standard configurations, typically categorized as one of uprights, slat tops, or bar tops. These machines are found in casinos, Amerindian bingo halls, bars, and the like. Bar top machines are set into the countertop of a bar so that patrons of the establishment may play gaming machines while seated adjacent to the bar counter, often while consuming beverages and/or food served by a bar tender. Bar top machines typically have flat, or slightly upraised, upper surfaces where the player views the screen looking down through a glass top or cover. This allows for the constant cleaning needed in a bar environment, as well as the need for waitrons and customers to reach over the gaming machine for drinks, food, etc. The screen in a typical bar top machine may be a cathode ray tube or flat panel display with an aspect ratio of 4×3. Other peripheral components required for the operation of the bar top machine such as, but not limited to, player control buttons, a bill acceptor, a voucher printer and player tracking system hardware are generally installed protruding from the top of the machine around the outside edges of the display. The need to allow player access to the various peripherals and the limited space available in a traditional bar top unit footprint (for example, approximately 27 inches wide by 17 inches deep) has necessarily limited the dimensions of displays mounted in bar top units.

Recent developments in gaming machine cabinets other than bar top units, for example, upright or slant top gaming machines, have included the used of displays with a “wide-screen” aspect ratio, for example, 16×9. Use of a wide display aspect ratio with a 28″ LCD or 32″ LCD flat panel display, for example, has several advantages. It allows for simultaneous display of pay tables with normally sized game play displays, reducing the need for a player to switch to help screens. A wide display can be logically divided into two or more viewing areas that can be used for showing different images. One viewing area may always include the primary game while the others can include the aforementioned pay tables and/or bonus games, player tracking information, special promotions, or just entertaining visual sequences. A wide-screen also has the desirable trait of consuming significantly more of a player's peripheral vision than a standard screen, reducing visual distractions from the sides. There is a need for improved bar top gaming machines capable of supporting a wide-screen display without requiring a larger installation footprint.

### SUMMARY OF THE INVENTION

In accordance with one embodiment of the invention, a bar top gaming machine includes a housing including a bottom, back, two opposite sides and a front. A top including a display is attached to the housing and is movable from a first position to a second position. A player input device is attached to the housing and a currency acceptor is mounted to the interior of the housing and disposed within the longitudinal confines of the display. The housing contains gaming electronics and logic to enable said player input device to be usable to play a game whose outcome is at least partially based on a random event. In accordance with one or more embodiments of the invention, the display provides at least 1.5 times more display surface than a bar top gaming machine mountable in the same footprint with its currency acceptor disposed outside the longitudinal confines of its display.

In accordance with another embodiment of the invention, a gaming machine includes a housing including a bottom, back, two opposite sides and a front and a top including a display assembly attached to the housing. The top is movable from a first position to a second position. The gaming machine also includes a player input device attached to the housing. A currency is acceptor mounted to the interior of the housing, the majority of a body of the currency acceptor situated beneath the display assembly when the top is in the first position. A first chute is connected to the top, the first chute allowing the passage of currency from the exterior of the housing to the currency acceptor when the top is in the first position. The housing contains gaming electronics and logic to enable the player input device to be usable to play a game whose outcome is at least partially based on a random event.

In accordance with another embodiment of the invention, a method for constructing a gaming machine includes the steps of attaching a currency acceptor to a housing of the gaming machine, attaching a first end of at least one hinge to the housing of the gaming machine and attaching a second end of the at least one hinge to a top panel. The top panel includes a display and is movable from a first position to a second position. The method further includes the steps of attaching a first paper chute to the top panel such that, when the top panel is in the first position, the first paper chute is aligned with an input portion of the currency acceptor and the majority of a body of the currency acceptor is situated beneath the display. In accordance with another embodiment, a printer may be similarly attached to the housing whereby an output portion of the printer is aligned with a second paper chute attached to the top panel when the top panel is in the first position.

The features and advantages of the present invention will become apparent from the following detailed description, taken in conjunction with the accompanying drawings, which illustrate by way of example, the features of the various embodiments.

### DESCRIPTION OF THE DRAWINGS

FIGS. 1A and 1B are front perspective views of a bar top gaming unit in accordance with one embodiment of the invention.

In accordance with one embodiment of the invention, FIG. 2 is a block diagram of a portion of the physical and logical components of the gaming machine of FIGS. 1A-B relating to a gaming machine motherboard.

FIGS. 3A and 3B illustrate hinge operation in accordance with one embodiment of the invention.

FIG. 4 illustrates a paper chute employed in one embodiment of the invention.

FIG. 5 is a flow diagram depicting the steps associated with carrying out a method in accordance with one embodiment of the invention.

FIG. 6 illustrates a mounting ring employed in one embodiment of the invention.

FIG. 7 comparatively illustrates the improved surface area of a wide screen display apparatus of the present invention versus a prior art bartop display apparatus with width-wise mounted currency acceptor and ticketing sub-assemblies.

### DETAILED DESCRIPTION OF THE INVENTION

Persons of ordinary skill in the art will realize that the following description of the present invention is illustrative only and not in any way limiting. Other embodiments of the invention will readily suggest themselves to such skilled persons having the benefit of this disclosure.

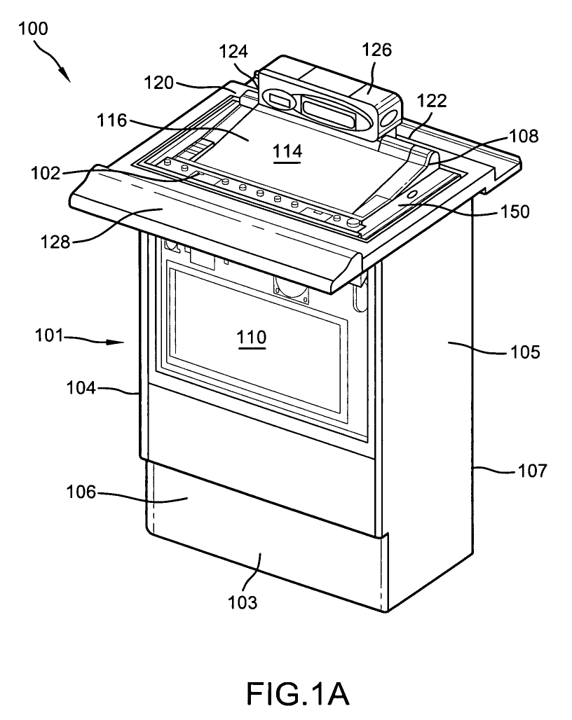

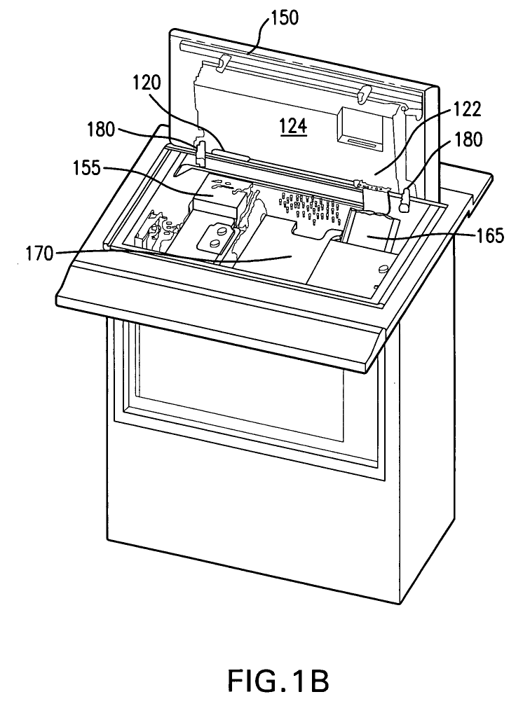

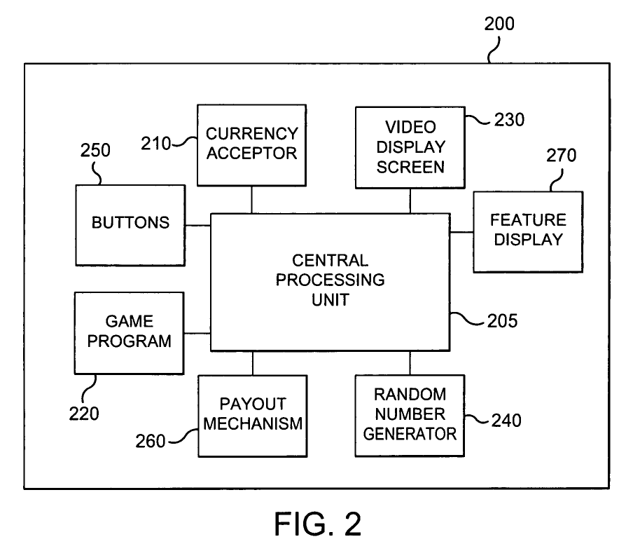

Referring to the drawings, for illustrative purposes the present invention is shown embodied in FIGS. 1 through 5. It will be appreciated that the apparatus may vary as to configuration and as to details of the parts without departing from the novel concepts disclosed herein. Methods may vary as to details, partitioning, repetition, step inclusion, and the order of the acts, without departing from the novel concepts disclosed herein.

The various embodiments of the invention include a wide-screen display mounted in a top of a bar top gaming machine cabinet. Peripherals such as a currency acceptor and/or printer are installed in the interior of the cabinet beneath the display. Paper chutes extend from these peripherals to the exterior of the cabinet. This mounting scheme allows a wide-screen display, for example, a 20-inch diagonal wide-screen, to be implemented in a standard bar top footprint, though other footprints larger or smaller may be occupied by displays of any size without deviating from the scope and spirit of the invention.

Referring to FIG. 1A, in accordance with one embodiment of the invention, gaming machine 100 may present a video or mechanical reel slot machine, a video keno game, a lottery game, a bingo game, a Class II bingo game, a roulette game, a craps game, a blackjack game, a mechanical or video representation of a wheel game or the like. In alternative embodiments, it may further be appreciated that games of skill or games of chance involving some player skill may be implemented with gaming machine 100.

In one embodiment, gaming machine 100 includes cabinet housing 101 defined by a base 103 (obscured). First and second sides 104 (obscured) and 105 extend upwardly from opposing edges of base 103. The housing 101 also comprises front and rear walls 106 and 107 (obscured) which extend upwardly from base 103. The front and rear walls 106 and 107 extend between the first and second sides 104 and 105, defining a perimeter of cabinet housing 101. In one embodiment, housing 101 is generally rectangular in shape with front and rear walls 106 and 107 longer than sides 104 and 105. Base 103, sides 105 and 106 and front and rear walls 106 and 107 define an interior area. The first and second sides 104 and 105 and front and rear walls 106 and 107 have a top edge forming the perimeter of the top of housing 101. In one embodiment, front wall 106 has an opening providing access to the interior of housing 101. A front panel 110 is movably connected with, for example, one or more hinges to housing 101 that allow opening and closing the opening in front wall 106. As illustrated, front panel 110 is in the closed position. Cabinet housing 101 may be manufactured with reinforced steel or other rigid materials which are resistant to tampering and vandalism. In one embodiment, a base 103 (obscured), first and second sides 104 (obscured) and 105, and front and rear walls 106 and 107 (obscured) are constructed of metal. For example, metal plates or panels may be connected, such as by bolts or welding, or may be formed as a single unit.

In one embodiment, front panel 110 also comprises a panel, preferably movable between a first position in which it generally closes the opening in front wall 106 of the housing 101, and a second position in which the opening is accessible. Front panel 110 comprises a lower edge movably connected to housing 110 with a hinge (not shown). The hinge connects the lower edge of front panel 110 to the housing 101. Front panel 110 may be connected to housing 101 in other manners, for example, by more than one hinge. Additionally, in some embodiments, front panel 110 may be held in place by fasteners, for example, screws, bolts or latches, and may be removed and replaced as desired. Front panel 110 will typically be lockable.

Cabinet housing 101 includes player control area 102. This will typically be a button deck or button area having one or more buttons used for on-going game play. As used herein, “player controls,” “input controls,” “input devices” and similar phrases refer to the controls a player will use while playing the game of chance (poker, reels, bingo, keno, etc.). The player controls may be used for various functions such as, but not limited to, selecting a wager denomination, selecting a game to be played, selecting a wager amount per game, initiating a game, or cashing out money from gaming machine 100. For example, one input device is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand. Any player input device or combination of devices, for example, a track ball, joystick, touch screen system, touch pad, mouse, switches, toggle switches, or any other input means may be used to accept player input. Any type of player input devices are contemplated in combination with the player control area 102 of the presently disclosed cabinet. This explicitly includes embodiments where the player controls may be touchscreen technologies on the main display, and where it is possible to have the bar top gaming cabinet disclosed herein having no player input devices.

Armrest 128, shown as a stepped armrest, allows resting of arms, elbows and/or wrists while maintaining finger access to player input devices 102 and any other areas on or near the frontal area of gaming machine 100. Armrest 128 may be any configuration intended to enable comfortable resting of elbows, forearms, and wrists, etc. In the embodiment shown the areas are substantially flat, but other embodiments are fully contemplated, such as having armrest 128 at varying angles relative to button deck 102. Bolster or armrest 128 is expected to be a resilient, firm but pliable fascia attached to the front of player input area 102. Fascia 108 is designed to contain bill acceptor and voucher printers/readers, player card readers, and similar I/O devices. Also shown are typical gaming machine peripherals including bill acceptor paper chute 120, printer paper chute 122, card reader 124, and player tracking system display 126 (preferably Bally Technologies' iView™ product). These devices are placed so that a player can see and, in most cases, operate them while resting his/her arms and/or wrists on armrest 128 of cabinet 100. Any set of gaming peripherals may be used with the gaming machine disclosed herein; shown is one exemplar embodiment.

Adjacent to player control area 102 is large color display 114 mounted in display assembly 124 (FIG. 1B). In one embodiment the display is a flat panel display having an aspect ratio of 16×9, such as 20″ LCD display mounted in landscape mode (positioned with its longer axis parallel to the deck areas). The flat panel display is preferably a high resolution LCD display, although lower resolutions may be used. Additionally, in other embodiments, the display make take the form of flat-panel displays in the form of, but not limited to, liquid crystal, plasma, electroluminescent, vacuum fluorescent, field emission, or any other type of panel display known or developed in the art. The preferred embodiment of display 114 uses flat panel display technology, as their use allows the gaming machine to have an overall depth similar to gaming machines already in use while positioning components such as currency acceptor 155 and printer 165 inside the cabinet beneath the display assembly 124 instead of around the periphery of the display. This gives the cabinet described herein a footprint approximately equal to bar top gaming machines already installed in casino bars while providing a larger, more capable display 114.

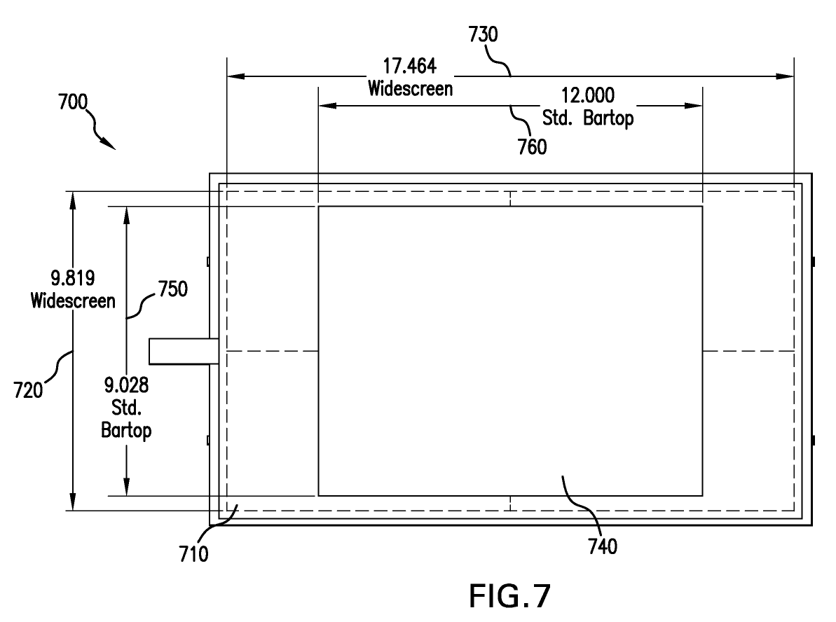

By way of example, FIG. 7 shows a comparison 700 between the available display surface area of a “standard” 4×3 aspect ratio display 740 with dimensions 12 inches wide (760) and 9.028 inches deep (750) and a widescreen display 710 with dimensions of 17.464 inches wide (730) and 9.819 inches deep (720), both displays capable of being mounted in a display assembly having an approximate width and depth of 26 inches wide by 16 inches deep.

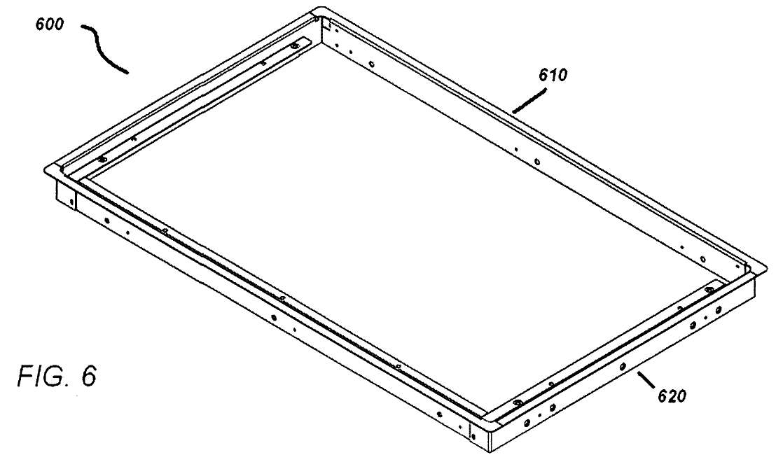

Referring again to FIG. 1A, cabinet housing 101 is typically mounted through an opening in the surface of a bar or counter (not shown) such that the upper portion of the gaming machine including display 114, player control area 102 and the other elements requiring player access are exposed to a player while the remainder of the housing is concealed beneath the bar or counter. In accordance with one or more embodiments, FIG. 6 illustrates a mounting ring 600 with long sides 610, which may be, for example, approximately 27 inches long, and shorter sides 620, which may be, again for example, approximately 17 inches long. The mounting ring 600 is attached to the inner surface of the cut-out bar top opening with fasteners such as screws. Cabinet housing 101 is then similarly attached to the mounting ring.

Also illustrated on FIG. 1A is touch screen 116. Any touch screen technology may be used, for example, a controller and touch screen manufactured by MicroTouch. In one embodiment display 114 is slightly angled from vertical. In other embodiments, it is contemplated that display 114 is mounted horizontally. In one embodiment, the inclination angle is set at 4 degrees. It is expected that the inclination angle will typically be set from 0 degrees to 10 degrees, with most embodiments between 4 and 7 degrees. The inclination angle helps with anti-glare, as well as accommodating players having differing torso lengths and the occasional player who plays while standing. Display 114 and fascia 108 are mounted to a top door or hatch 150 which provides access to the interior of cabinet 100 when opened. Turning to FIG. 1B, in accordance with one embodiment of the invention, top panel 150 is shown in an open position, exposing currency acceptor 155 and printer 165. The bottom of the display assembly 124 overlays the majority of the bodies of currency acceptor 155 and printer 165 when top panel 150 is closed. This conservation of top surface space allows display assembly 124 and display 114 to be as large as possible while maintaining a standard bar top cabinet footprint. Cabinet housing 101 houses a processor, circuitry, and software (not shown) for receiving signals from player-activated input devices in player control area 102, operating the games, and transmitting signals to the display and speakers. A lockable inner removable or hinged hatch 170 may be installed to prevent unauthorized access to the processor, circuitry and software. In one embodiment, the gaming machine controller is housed within a locked removable case such that the individual components of the gaming controller, such as a mother board including the central processing unit, are protected from tampering yet easily removed for servicing by authorized personnel.

In accordance with one embodiment of the present invention, FIG. 2 is a block diagram showing the interconnection of the physical and logical components 200 of gaming machine 100. Currency acceptor 210, for example, a JCM American Corporation Model WBA, is typically connected to a conventional central processing unit (“CPU”) 205, such as an Intel Pentium microprocessor mounted on a gaming motherboard, by a serial connection such as RS-232 or USB. Other manufacturers of the CPU may be, for example, one of those commercially available from companies such as Sun Microsystems or AMD. The gaming motherboard may be mounted with other conventional components, such as are found on conventional personal computer motherboards, and loaded with a gaming machine operating system (OS), such as an Alpha OS by Bally Technologies. CPU 205 executes game program 220 that causes video display screen 230 to display a game. When a player has inserted a form of currency such as, for example and without limitation, paper currency, coins or tokens, cashless tickets or vouchers, electronic funds transfers or the like into currency acceptor 210, a signal is sent to CPU 205 which, in turn, assigns an appropriate number of credits for play. The player may further control the operation of gaming machine 100, for example, to select the amount to wager via electromechanical or touchscreen buttons 250. The game starts in response to the player pushing one of buttons 250 or an alternate start mechanism such as a handle or touchscreen icon (not shown). Random number generator 240 responds to instructions from CPU 205 to provide a display of randomly selected indicia on video display screen 230. In some embodiments, random generator 240 may be physically separate from gaming machine 100; for example, it may be part of a central determination host system (not shown) which provides random game outcomes to CPU 205. Thereafter, the player may or may not interact with the game through electromechanical or touchscreen buttons 250 to change the displayed indicia. Finally, CPU 205 under control of game program 220 compares the final display of indicia to a pay table. The set of possible game outcomes may include a subset of outcomes related to the triggering of a feature game. In the event the displayed outcome is a member of this subset, CPU 205, under control of game program 220, may cause feature game play to be presented on video display screen 230.

Predetermined payout amounts for certain outcomes, including feature game outcomes, are stored as part of game program 220. Such payout amounts are, in response to instructions from CPU 205, provided to the player in the form of coins, credits or currency via payout mechanism 260, which may be one or more of a credit meter, a coin hopper, a voucher printer, an electronic funds transfer protocol or any other payout means known or developed in the art.

In various embodiments of gaming machine 200, game program 220 is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 200 are stored in the same or a separate memory device (not shown). Some or all of game program 220 and its associated data may be loaded from one memory device into another, for example, from flash memory to random access memory (RAM).

Returning to FIGS. 1A-B, top panel 150 may provide primary access to the interior of housing 101, for example, as a hatch for the removal of currency held by the currency acceptor, or maintenance access to various components in the interior of housing 101. Top panel 150 is connected to the housing 101 and movable between a position in which it generally encloses the otherwise generally open top of housing 101 (as illustrated in FIG. 1A) and a position in which the top of the housing 101 remains generally open (as illustrated in FIG. 1B). Top panel 150 may be connected to housing 101 by way of one or more articulating hinges 180 which allow top panel 150 to be raised above the surface of the bar counter prior to swinging into a fully open position. This prevents damage to the top of the counter and helps disengage paper chutes 120 and 122 from interfaced positions with currency acceptor 155 and printer 165, respectively.

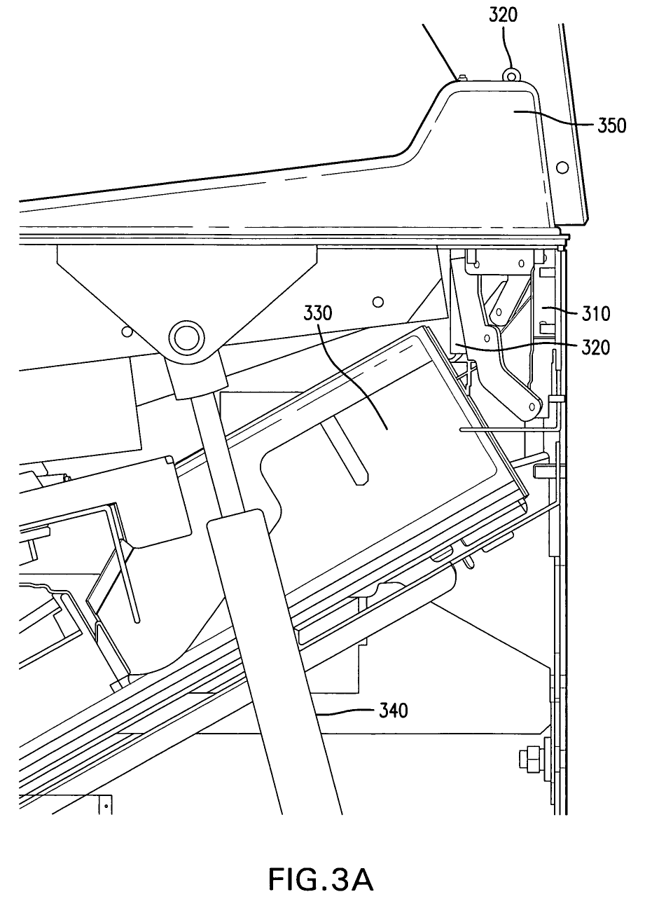

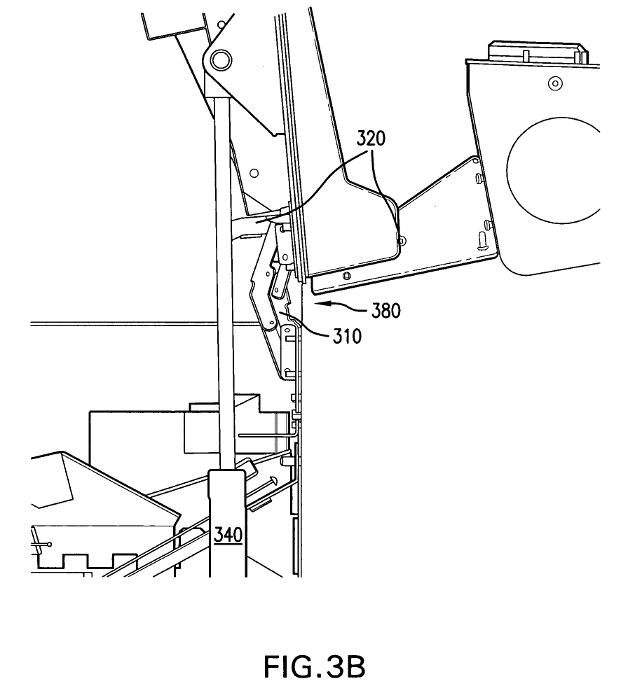

Referring to FIG. 3A, in accordance with one embodiment of the invention, articulating hinge 180 can be seen in its retracted, closed, position. Paper chute 122 extends from the top of fascia 108 to a position adjacent the paper exit of printer 165. When a voucher or ticket is printed, paper chute 122 provides a paper path from the printer to the exterior of the housing. In this view, top panel support strut 340 is shown in a compressed position. Turning to FIG. 3B, articulating hinge 180 and strut 340 are shown in their open, extended positions. The additional clearance between the top panel and the bar top provided by hinge 180 is indicated by line 380. Paper chute 320 has been retracted away from the position of printer 165 (not shown in FIG. 3B).

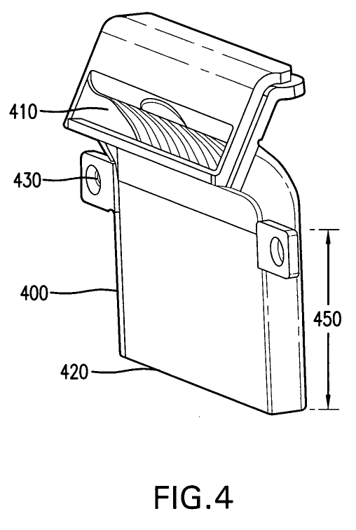

FIG. 4 illustrates a paper chute 400 in accordance with one embodiment of the invention. Chute 400 may be fabricated with, for example, metal, plastic or similar materials. Holes 430 may be used to attach chute 400 to the gaming machine. A throat extending from the top of the chute 410 to the bottom of the chute 420 provides a paper path for a currency acceptor or printer (not shown) mounted adjacent to the bottom of the chute 420. This design allows other components, for example, a display assembly, to be mounted in the vertical space 450 between the top 410 and bottom 420 of the chute. Only a small portion of the currency acceptor or printer must extend outside of the dimensions of the display assembly, allowing the display assembly to consume a larger footprint than previously possible in prior art bar top units.

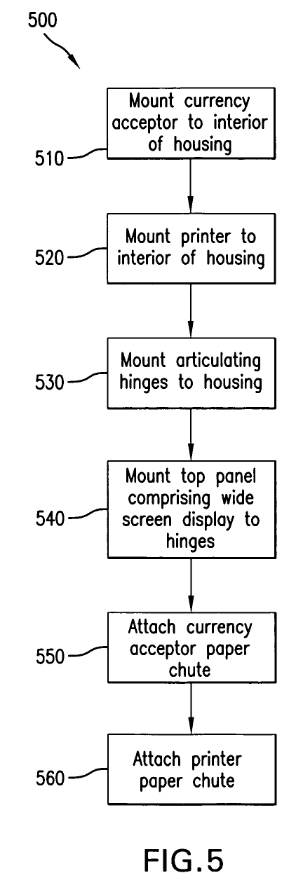

A logical flow diagram generally depicting the steps associated with a method 500 for constructing a bar top gaming unit in accordance with one aspect of the invention is presented in FIG. 5. The order of actions as shown in FIG. 5 and described below is only illustrative, and should not be considered limiting. For example, the order of the actions may be changed, additional steps may be added or some steps may be removed without deviating from the scope and spirit of the invention.

In step 510, a currency acceptor is mounted, for example, by way of fasteners such as screws and brackets, to the interior of a housing of a bar top gaming unit.

In step 520, a voucher printer is mounted, for example, by way of fasteners such as screws and brackets, to the interior of the housing.

In step 530, one end of one or more articulating hinges are attached to the housing of the gaming unit, for example, by using fasteners such as screws or by welding.

In step 540, a top panel comprising a wide-screen display is similarly attached to the other end of the hinges.

In step 550, a paper chute is attached to the top panel using, for example, sheet metal screws through mounting holes in the paper chute, the bottom of the paper chute aligned with the currency acceptor acceptance slot when the top panel is closed. The majority of the body of the currency acceptor is positioned beneath the body of the display.

In step 560, a paper chute is attached to the top panel using, for example, sheet metal screws through mounting holes in the paper chute, the bottom of the paper chute aligned with the voucher issuance slot of the printer when the top panel is closed. The majority of the body of the printer is positioned beneath the body of the display.

Although the description above contains certain specificity, the described embodiments should not be construed to indicate the scope of the invention; the descriptions given are providing an illustration of certain preferred embodiments of the invention. For example, in one embodiment, the bar top unit may have a currency acceptor but no printer. In another embodiment, the bar top unit may have a printer but no currency acceptor. The scope of this invention is determined by the appended claims and their legal equivalents.

What is claimed:

1. A bar top gaming machine comprising:
a housing comprising a bottom, back, two opposite sides and a front;
a top attached to the housing, the top movable from a first position to a second position and comprising a display;
a player input device attached to the housing;
a currency acceptor mounted to the interior of the housing and disposed within the longitudinal confines of the display;
wherein the housing contains gaming electronics and logic to enable said player input device to be usable to play a game whose outcome is at least partially based on a random event.

2. The gaming machine of claim 1 wherein the display provides at least 1.5 times more display surface than a bar top gaming machine mountable in the same footprint and comprising its currency acceptor disposed outside the longitudinal confines of its display.

3. The gaming machine of claim 1 further comprising a printer attached to the housing, the printer disposed within the longitudinal confines of the display.

4. The gaming machine of claim 3 wherein the display provides at least 1.5 times more display surface than a bar top gaming machine mountable in the same footprint and comprising its printer disposed outside the longitudinal confines of its display.

5. The gaming machine of claim 3 wherein the display provides at least 1.5 times more display surface than a bar top gaming machine mountable in the same footprint having the printer and currency acceptor disposed outside the longitudinal confines of the display.

6. The gaming machine of claim 1 wherein the display comprises an LCD display.

7. The gaming machine of claim 1 wherein the display comprises a plasma display.

8. The gaming machine of claim 1 wherein the display comprises a widescreen display.

9. The gaming machine of claim 1 further comprising at least one articulating hinge for attaching the top to the housing.

10. A gaming machine comprising:
a housing comprising a bottom, back, two opposite sides and a front;
a top comprising a display assembly attached to the housing, the top movable from a first position to a second position;
a player input device attached to the housing;
a currency acceptor mounted to the interior of the housing, the majority of a body of the currency acceptor situated beneath the display assembly when the top is in the first position;
a first chute connected to the top, the first chute allowing the passage of currency from the exterior of the housing to the currency acceptor when the top is in the first position;
wherein the housing contains gaming electronics and logic to enable said player input device to be usable to play a game whose outcome is at least partially based on a random event.

11. The gaming machine of claim 10 wherein the display assembly is mounted from 0 degrees to 10 degrees from horizontal.

12. The gaming machine of claim 11 wherein the display assembly is mounted 7 degrees from horizontal.

13. The gaming machine of claim 10 further comprising a printer mounted to the interior of the housing, the majority of a body of the printer situated beneath the display assembly when the top is in the first position; and
a second chute connected to the top, the chute allowing passage of paper from the printer to the exterior of the housing.

14. The gaming machine of claim 10 wherein the display assembly comprises an LCD display.

15. The gaming machine of claim 10 wherein the display assembly comprises a plasma display.

16. The gaming machine of claim 10 wherein the display assembly comprises a widescreen display.

17. The gaming machine of claim 10 further comprising at least one articulating hinge for attaching the top to the housing.

18. A method for constructing a gaming machine, the method comprising the steps of:
attaching a currency acceptor to a housing of the gaming machine;
attaching a first end of at least one hinge to the housing of the gaming machine;
attaching a second end of the at least one hinge to a top panel comprising a display, the top movable from a first position to a second position;
attaching a first paper chute to the top panel; wherein the first paper chute is aligned with an input portion of the currency acceptor and the majority of a body of the currency acceptor is situated beneath the display when the top panel is in the first position.

19. The method of claim 18 further comprising the steps of:
attaching a printer to the housing;
attaching a second paper chute to the top panel, wherein the second paper chute is aligned with an output portion of the printer and the majority of a body of the printer is situated beneath the display when the top panel is in the first position,

20. The method of claim 19 wherein the at least one hinge is an articulating hinge.

21. The method of claim 19 wherein the display comprises a widescreen display.

22. The method of claim 19 wherein the at least one hinge is attached to the housing by welding.

23. The method of claim 19 wherein the at least one hinge is attached to the housing by fasteners.
